(19) United States
(12) Patent Application Publication
(10) Pub. No.: US 2015/0120197 A1
(43) Pub. Date: Apr. 30, 2015

(54) Method of Transforming Reservoir Properties to a Seismic Attribute for Hydrocarbon and Lithology Identification

(71) Applicant: Tong Xu, Houston, TX (US)

(72) Inventor: Tong Xu, Houston, TX (US)

(73) Assignee: Chevron U.S.A. Inc., San Ramon, CA (US)

(21) Appl. No.: 14/067,528

(22) Filed: Oct. 30, 2013

(51) Int. Cl. G01V 1/48; G01V 1/40

(52) U.S. Cl. CPC G01V 1/48; G01V 1/40
USPC 702/14

(57) ABSTRACT

Embodiments of a method for transforming petrophysical properties into seismic attributes are disclosed herein. Embodiments of the method utilize an AVO expression which maps lithology to P-wave reflectivity at a particular angle through their λ/μ values (or equivalent elastic properties K/μ and γ). Rocks with different λ/μ will be projected to the different angle and reflectivity. The equation which transforms λ/μ to reflection angle may be referred to as a Generalized Angle Transform Equation (GATE). Further details and advantages of various embodiments of the method are described in more herein.

### CROSS-REFERENCE TO RELATED APPLICATIONS

Not applicable.

### STATEMENT REGARDING FEDERALLY SPONSORED RESEARCH OR DEVELOPMENT

Not applicable

### BACKGROUND

1. Field of the Invention

This invention relates generally to the field of geophysical exploration for hydrocarbons. More specifically, the invention relates to a method of transforming reservoir properties to reflection angles for hydrocarbon and lithology identification.

2. Background of the Invention

A seismic survey is a method of imaging the subsurface of the earth by delivering acoustic energy down into the subsurface and recording the signals reflected from the different rock layers below. The source of the acoustic energy typically comes from a seismic source such as without limitation, explosions or seismic vibrators on land, and air guns in marine environments. During a seismic survey, the seismic source may be moved across the surface of the earth above the geologic structure of interest. Each time a source is detonated or activated, it generates a seismic signal that travels downward through the earth, is reflected, and, upon its return, is recorded at different locations on the surface by receivers. The recordings or traces are then combined to create a profile of the subsurface that can extend for many miles. In a two-dimensional (2D) seismic survey, the receivers are generally laid out along a single straight line, whereas in a three-dimensional (3D) survey the receivers are distributed across the surface in a grid pattern. A 2D seismic line provides a cross sectional picture (vertical slice) of the earth layers as arranged directly beneath the recording locations. A 3D survey produces a data “cube” or volume that theoretically represents a 3D picture of the subsurface that lies beneath the survey area.

In the oil and gas industry, the primary goal of seismic exploration is locating subterranean features of interest within a very large seismic volume. Seismic data may provide information about the subsurface structure, stratigraphy, lithology and fluids contained in the rocks. Rock stratigraphic information may be derived through the analysis of spatial variations in a seismic reflector's character because these variations may be empirically correlated with changes in reservoir lithology or fluid content. Since the exact geological basis behind these variations may not be well understood, a common method is to calculate a variety of attributes from the recorded seismic data and then plot or map them, looking for an attribute that has some predictive value. Given the extremely large amount of data collected in a 3-D volume, methods of deriving information from the seismic data itself related to the migration, accumulation, and presence of hydrocarbons are extremely valuable in seismic exploration. Geophysicists often use log data and interpreted results supplied by a petrophysicist as input to tasks such as well-seismic ties, models of Amplitude as a function of Offset (AVO) models, seismic inversion and estimation of reservoir properties from seismic attributes. However, to date there has not been a method which enables geophysicists to quickly scan through the entire log interval and identify optimal P-wave reflection angles which indicate the presence of hydrocarbons and/or indicate lithology, and also quantify the separation between hydrocarbon and brine in the angle domain.

Consequently, there is a need for improved methods and systems to transform reservoir properties into seismic attributes for hydrocarbon and lithology identification.

### BRIEF SUMMARY

Embodiments of a method for transforming petrophysical/reservoir properties into seismic attributes are disclosed herein. Embodiments of the method utilize an AVO expression which maps lithology (which may range, for example and without limitation, from dry lithology to saturated shale) to P-wave reflectivity at a particular reflection angle through their λ/μ values (or equivalent elastic properties K/μ and γVₛ²/Vₚ²). Rocks with different λ/μ will be projected to different reflection angles and reflectivity. The equation which transforms λ/μ to reflection angle may be referred to as a Generalized Angle Transform Equation (GATE). Further details and advantages of various embodiments of the method are described in more detail below.

In an embodiment, a method of identifying the presence of hydrocarbons, the method comprises (a) acquiring one or more well logs from a subsurface region of interest. The one or more well logs comprise one or more petrophysical properties. The method also comprises (b) calculating one or more dry elastic properties using the one or more petrophysical properties to determine a plurality of dry reflection angles. In addition, the method comprise (c) transforming the one or more elastic properties for a selected depth interval from the one or more well logs into a plurality of wet reflection angles. The method further comprises (d) comparing the dry reflection angles and the wet reflection angles to quantify a fluid discrimination measurement and (e) based on the fluid discrimination measurement, using the reflection angles in (b) and (c) to identify one or more hydrocarbon formations in a seismic dataset from another subsurface region of interest. At least one of (b) through (e) is performed on a computer.

In an embodiment, a method of identifying the lithology of a subsurface region of interest, the method comprises (a) acquiring one or more well logs from a subsurface region of interest, where the one or more well logs comprise one or more petrophysical and lithological properties. The method also comprises (b) calculating a bulk and shear moduli using the one or more petrophysical properties to determine a plurality of reflection angles and (c) plotting the plurality of reflection angles and the one or more lithological properties to determine a relationship between the one or more lithological properties and the reflection angles, where at least one of (b) and (c) are performed on a computer.

In another embodiment, a computer system comprises an interface for receiving one or more well log datasets. The well log datasets comprising one or more petrophysical properties. The system also comprises a memory resource. The system further comprises input and output functions for presenting and receiving communication signals to and from a human user. In addition, the system comprises one or more central processing units for executing program instructions and program memory, coupled to the central processing unit, for storing a computer program including program instructions that, when executed by the one or more central processing units, cause the computer system to perform a plurality of operations for identifying one or more hydrocarbon formations, the plurality of operations comprising (a) calculating one or more dry elastic properties using the one or more petrophysical properties to determine a plurality of dry reflection angles. The plurality of operations also comprises (b) transforming the one or more elastic properties for a selected depth interval from the one or more well logs into a plurality of wet reflection angles. Furthermore, the plurality of operations comprises (c) comparing the dry reflection angles and the wet reflection angles to quantify a fluid discrimination measurement and (d) based on the fluid discrimination measurement, using the wet and dry reflection angles in (a) and (b) to identify one or more hydrocarbon formations in a seismic dataset from another subsurface region of interest.

The foregoing has outlined rather broadly the features and technical advantages of the invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawings in which:

FIGS. 1A and 1B illustrate an exemplary plot of a plurality of well logs as a result of an embodiment of the disclosed method.

FIG. 2 illustrates a flowchart of an embodiment of a method for transforming petrophysical/reservoir properties to a seismic attribute;

FIG. 3 illustrates a plot of K_{dry}/μ and total porosity (Φ_{T}) from a sand reservoir. The dry elastic properties were calculated from the wire-line logs using the Gassmann equation;

FIG. 4 illustrates a plot of reflection angles versus dry λ/μ values as a result of the angle transform equation. The λ/μ is from real wire line logs and was converted to dry λ/μ values using the Gassmann equation;

FIG. 5A illustrates a process to transform the lithology to reflection angle, θ shows the cross plot of dry frame λ/μ and Vₛₕ from real wire line data;

FIG. 5B shows the transform from λ/μ to reflection angle, θ, for the same data set as in FIG. 5A. The black line indicates the transform path.

FIG. 6 shows a cross plot between reflection angles (obtained via Equation (3)) and Vₛₕ. The plot was generated using the same data set as that used in FIG. 2. A good correlation (CC=85%) was achieved between angle and lithology; and

FIG. 7 illustrates a schematic of a system which may be use in conjunction with embodiments of the disclosed methods.

### NOTATION AND NOMENCLATURE

Certain terms are used throughout the following description and claims to refer to particular system components. This document does not intend to distinguish between components that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct connection. Thus, if a first device couples to a second device, that connection may be through a direct connection, or through an indirect connection via other devices and connections.

As used herein, “dry elastic properties” refers to the elastic properties of a dry porous subsurface solid such as, without limitation, rock, sand, shale, etc.

As used herein, “dry reflection angle” refers to the angle at which a seismic signal maximally reflects from a dry formation.

As used herein, “wet elastic properties” refers to the elastic properties of a porous subsurface solid (such as, without limitation, rock, sand, shale, etc.) saturated with brine.

As used herein, “wet reflection angle” refers to the angle at which a seismic signal maximally reflects from a subsurface formation saturated with brine.

As used herein, “seismic trace” refers to the recorded data from a single seismic recorder or seismograph and typically plotted as a function of time or depth.

### DETAILED DESCRIPTION OF THE PREFERRED EMBODIMENTS

Referring now to the Figures, embodiments of the disclosed methods will be described. As a threshold matter, embodiments of the methods may be implemented in numerous ways, as will be described in more detail below, including for example as a system (including a computer processing system), a method (including a computer implemented method), an apparatus, a computer readable medium, a computer program product, a graphical user interface, a web portal, or a data structure tangibly fixed in a computer readable memory. Several embodiments of the disclosed methods are discussed below. The appended drawings illustrate only typical embodiments of the disclosed methods and therefore are not to be considered limiting of its scope and breadth.

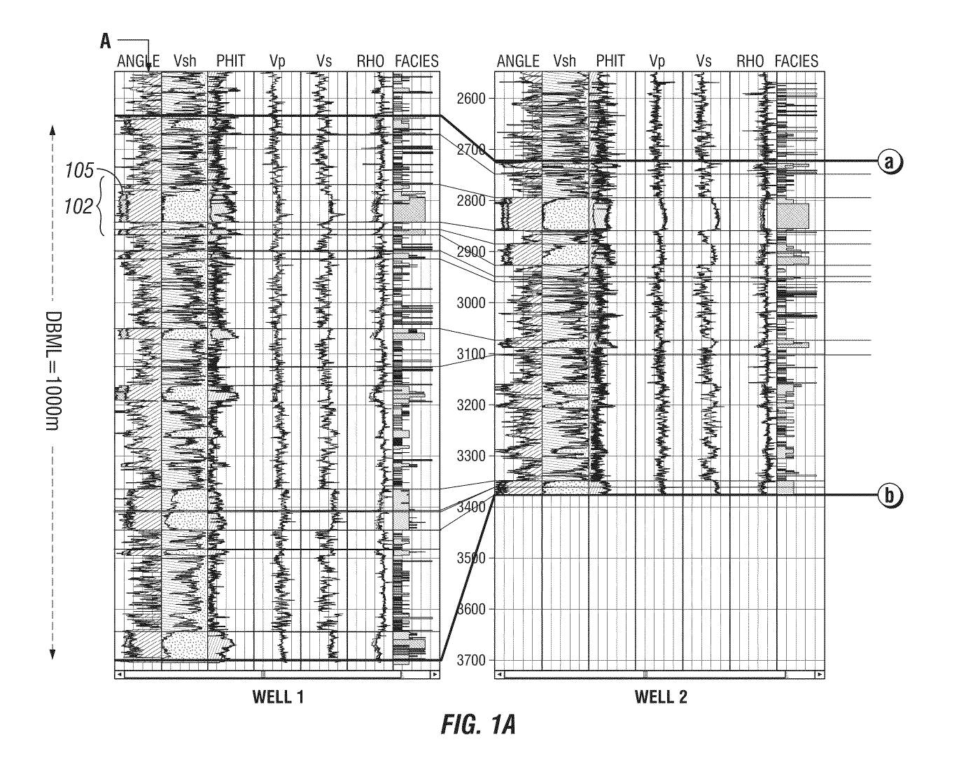

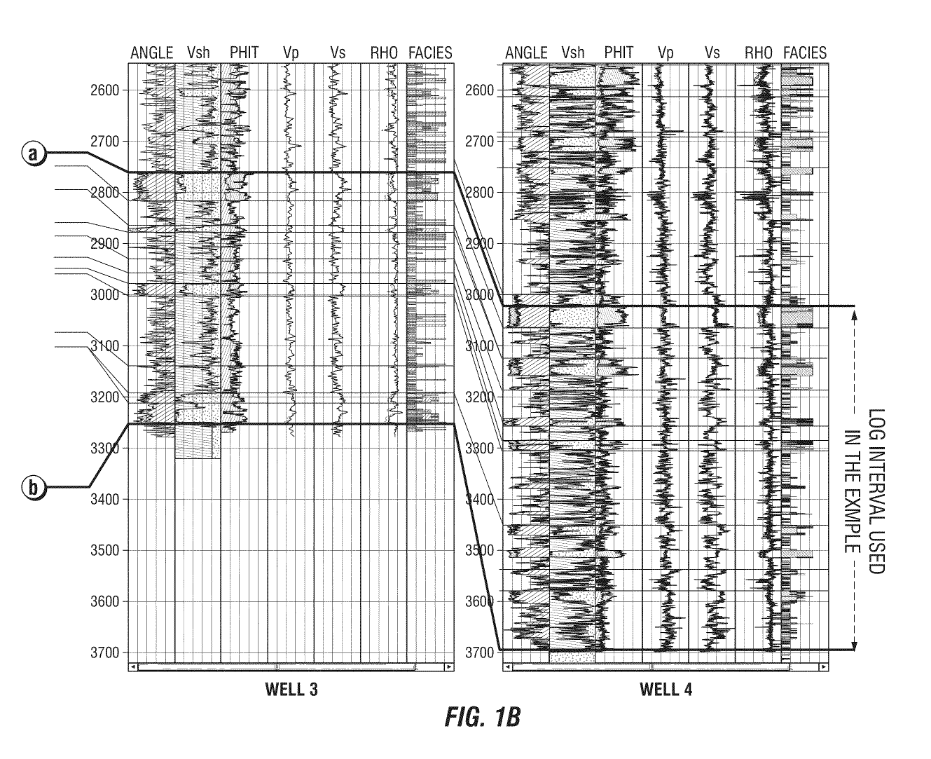

FIGS. 1A-B and 2 illustrate an embodiment of the method 200. In 201, one or more well logs may be acquired from an area or region of interest which may contain or has been identified as having hydrocarbons. The one or more well logs may be acquired may any method known to those of skill in the art. Examples of suitable well logging techniques include without limitation, wireline logging, resistivity logging, or combinations thereof. The one or more well logs may include one or more petrophysical and/or lithological measurements or datasets. Any petrophysical data known to those of skill in the art may be included in the well logs. Examples of such petrophysical data include without limitation, density, porosity, neutron, compressional sonic, shear sonic, magnetic resonance, resistivity, gamma ray, lithology, water saturation, permeability, and the like. In an embodiment, the one or more well logs contain at least Vₛₕ and λ/μ values. FIG. 1 illustrates an exemplary well log which may be plotted as result of embodiments of the disclosed methods

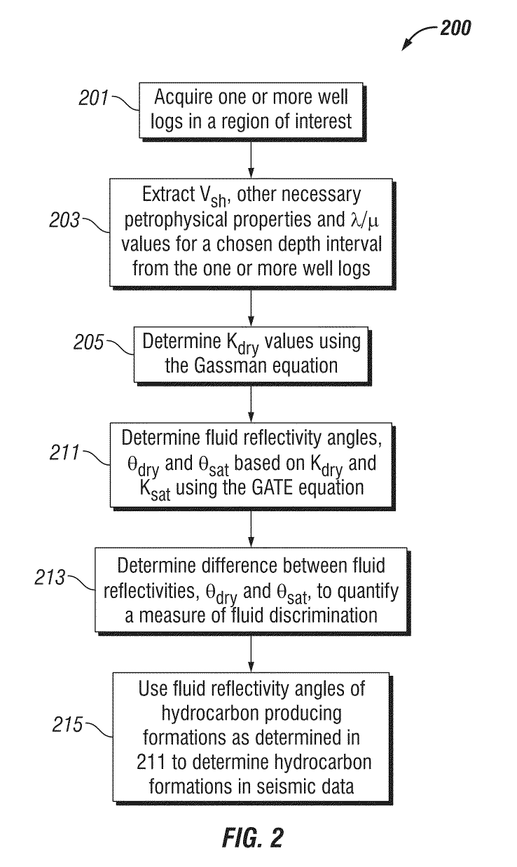

Referring to FIG. 2, in an embodiment, in block 203, the measured volumetric fraction of shale, Vₛₕ and λ/μ values, where λ is Lamè's first constant and μ is the shear modulus or Lamè's second constant, may be extracted or determined from the well logs. As is known the art,

$$λ = K - \frac{2}{3} μ \qquad ( 1 )$$

where K is bulk modulus. Vₛₕ and λ/μ values may be extracted for any selected depth interval or range of interest. For example, if the subsurface geology of interest may be from 10,000 ft to 15,000 ft, then the well log data from that depth interval may be selected. The Vₛₕ and λ/μ values may be extracted from a single log or multiple logs representing multiple wells in the region of interest.

In an embodiment, K_{dry}, the bulk modulus of dry rock, may be determined using a modified form of Gassman equation in block 205 as detailed below. The Gassmann equation can be expressed as:

$$\begin{matrix}{K}_{sat} = ( 1 - β ) {K}_{m} + {β}^{2} M & ( 2 a ) \\ {K}_{dry} = ( 1 - β ) {K}_{m} & ( 2 b ) \\ \frac{1}{M} = \frac{β - ∅}{{K}_{m}} + \frac{∅}{{K}_{f}} & ( 2 c )\end{matrix}$$

Where, Kₛₐₜ, K_{dry}, K_{f} and Kₘ are the bulk moduli of saturated rock, dry rock, fluid and mineral. Φ is the total porosity and β is the Boit coefficient. Combining equations (2a) and (2b), the following equation is obtained:

Kₛₐₜ=K_{dry}+β²M (2d)

Since Kₘ>>K_{f}, equations (2b), (2c), and (2d) are merged into

$${K}_{sat} - {K}_{dry} \approx {( 1 - \frac{{K}_{dry}}{{K}_{m}} )}^{2} ( \frac{{K}_{f}}{φ} ) \qquad ( 2 e )$$

Since Kₛₐₜ, Kₘ, K_{f}, and φ are all known through data acquired from the one or more well logs, K_{dry} may be determined using Equation (2). Substituting K_{dry} value, as determined by Equation (2e), back into Equation (1), the λ/μ value of dry rock may be determined as the μ is fluid independent property.

In block 211, the λ/μ values, both dry and wet, may then be transformed into seismic reflection angles, θ, using the equation below:

$${sin}^{2} θ = \frac{( \frac{λ}{μ} + 2 ) ( 1 + b )}{( 6 + 4 b - \frac{λ}{μ} )} \qquad ( 3 )$$

where b is a constant Gardner power coefficient. In one embodiment, b may be equal to 0.25. However, any suitable value of b may be used.

The derivation of Equation (3) is described in detail below. Measured data on sands and sandstones suggest that a dry K/μ ratio tends to be a constant for a sample and vary systematically with rock texture for different samples.

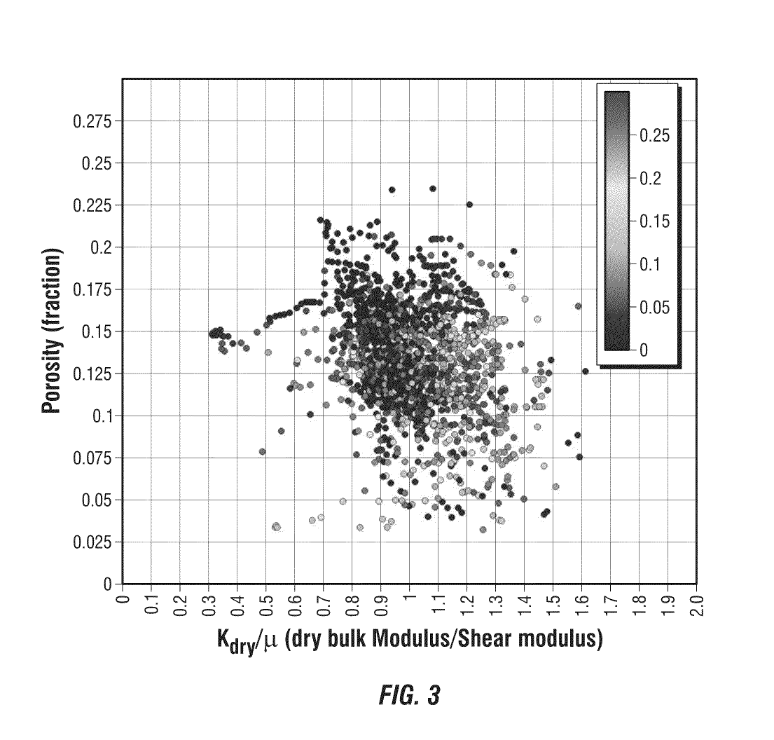

FIG. 3 shows the cross plot of total porosity (Φ_{T}) versus K_{dry}/μ from sample log measurements of sandstone reservoirs. The K_{dry}/μ is shown centered around 1.0 with a spread of ±0.3, which is consistent with the observations made in the literature. K_{dry}=α*μ is assumed, where α is a constant.

Kₛₐₜ−K_{dry}=Kₛₐₜ−αμ (3a)

The fluid term F is defined as

F=Kₛₐₜ−αμ (3b)

According to equation (2e), F in equation (3b) is an excellent fluid indicator. The subscript “sat” is omitted and K is used to represent the in-situ (or saturated) bulk modulus. Then, the reflectivity of F can be expressed as

$${R}_{f} = \frac{Δ F}{2 F} = \frac{Δ K - α Δ μ}{2 ( K - α μ )} \qquad ( 3 c )$$

A formula to express R_{f} will now be derived as a function of the traditional AVO attributes A, B and C. The following are standard relations between moduli and velocities and density

$$\{ \begin{matrix}{V}_{p}^{2} ρ = K + \frac{4}{3} μ \\ {V}_{s}^{2} ρ = μ\end{matrix} \} \qquad ( 3 d )$$

Where Vₚ, Vₛ, ρ are P-wave velocity, S-wave velocity, and density respectively. Taking the derivative of equation (3d), the following equations are obtained:

$$\begin{matrix}Δ K + \frac{4}{3} Δμ = {V}_{p}^{2} Δρ + 2 {V}_{p} Δ {V}_{p} ρ and & ( 3 e ) \\ Δμ = {V}_{s}^{2} Δρ + 2 {V}_{s} Δ {V}_{s} ρ . & ( 3 f )\end{matrix}$$

Reflectivity can be written in linearized form of the intercept (A) and gradient (B) as (the linearized Zoeppritz equation or Aki-Richard's AVO equation):

R(θ)=A+B sin² θ+C sin² θ tan² θ (3g).

The intercept A represents the zero-offset P-wave reflectivity, which can be written

$$A = {R}_{P 0} = \frac{1}{2} [ \frac{Δ {V}_{P}}{{V}_{P}} + \frac{Δ ρ}{ρ} ] , \qquad ( 3 h )$$

where ΔVₚ and Δρ are the changes in P-wave velocity and density across the layer boundaries, and Vₚ and ρ are the average P-wave velocity and density across the layer boundaries.

The gradient term in the Aki-Richards equation can be written as:

$$B = \frac{1}{2} \frac{Δ {V}_{P}}{{V}_{P}} - 4 {( \frac{{V}_{S}}{{V}_{P}} )}^{2} \frac{Δ {V}_{S}}{{V}_{S}} - 2 {( \frac{{V}_{S}}{{V}_{P}} )}^{2} \frac{Δ ρ}{ρ} . \qquad ( 3 i )$$

The third term, C, can be written:

$$C = \frac{1}{2} \frac{Δ {V}_{P}}{{V}_{P}} \qquad ( 3 j )$$

Solving for ΔVₚ/Vₚ, ΔVₛ/Vₛ, and Δρ/ρ in terms of A, B, and C, then substitute them into equations (3e) and (3f), we will have

$$\begin{matrix}Δ K = \frac{2 ( 3 A + B + 2 C )}{3} \times {V}_{p}^{2} ρ & ( 3 k ) \\ and Δ μ = \frac{( C - B )}{2} \times {V}_{p}^{2} ρ . & ( 3 l )\end{matrix}$$

Since ΔF=ΔK−αΔμ,

$$Δ F = [ 2 A + ( \frac{2}{3} + \frac{1}{2} α ) B + ( \frac{4}{3} - \frac{1}{2} α ) C ] {V}_{p}^{2} ρ . \qquad ( 3 m )$$

From equations (3b) and (3d):

$$F = [ 1 - ( \frac{4}{3} + α ) \frac{{V}_{s}^{2}}{{V}_{P}^{2}} ] {V}_{p}^{2} ρ \qquad ( 3 n )$$

With equations (3m) and (3n), the fluid reflectivity defined in equation (3c) can be expressed as

$${R}_{f} = \frac{[ A + ( \frac{1}{3} + \frac{1}{4} α ) B + ( \frac{2}{3} - \frac{1}{4} α ) C ]}{[ 1 - ( \frac{4}{3} + α ) γ ]} , \qquad ( 30 )$$

where γ=Vₛ²/Vₚ². Equation (3o) shows that the fluid reflectivity is the linear combination of AVO attributes A, B, and C.

If the density and P-wave velocity follow a power low relationship, the ratio of AVO attributes, C/A, is approximated by a constant. For the original Gardner's relationship, the constant is 0.8. Without losing generality, ρ=aVₚ^{b} is assumed, where a and b are constants. Then

$$\frac{C}{A} = \frac{1}{1 + b} \qquad ( 3 p )$$

Then equation (3o) may be further simplified to

$${R}_{f} = [ A + \frac{\frac{1}{3} + \frac{1}{4} α}{1 + ( \frac{2}{3} - \frac{1}{4} α ) \times \frac{1}{1 + b}} B ] \times \frac{1 + ( \frac{2}{3} - \frac{1}{4} α ) \times \frac{1}{1 + b}}{1 - ( \frac{4}{3} + α ) γ} \qquad ( 3 q )$$

where Equation (3q) may be referred to as the fluid reflectivity equation.

Recent studies have indicated that λ/μ may be used as a good sand shale discriminator. Below, the reflectivity of λ/μ is derived in terms of AVO attributes, A, B, and C, and then be related to the P-wave reflectivity at a particular angle.

L is defined as λ/μ. As such Rₗ, the reflectivity of L, is

$${R}_{l} = \frac{Δ L}{2 L} = Δ ( \frac{λ}{μ} ) / 2 ( \frac{λ}{μ} ) ( 3 r )$$

$${R}_{l} = {R}_{λ} - {R}_{μ} ( 3 s ) ,$$

where R_{λ}=Δλ/2λ and R_{μ}=Δμ/2μ. The following equations are then used:

$${R}_{λ} = ( \frac{A ( 2 + \frac{1}{1 + b} )}{2 - 4 γ} + \frac{B}{2 - 4 γ} ) and {R}_{μ} = ( \frac{A}{4 γ ( 1 + b )} - \frac{B}{4 γ} ) \qquad ( 3 t )$$

where b is Gardner power coefficient and γ=Vₛ²/Vₚ². After substituting equation (3t) into (3s) and regrouping, the result is:

$${R}_{l} = {R}_{λ} - {R}_{μ} = \frac{4 γ + \frac{4 γ}{1 - b} - \frac{1}{1 - b}}{4 γ ( 1 - 2 γ )} A + \frac{1}{4 γ ( 1 - 2 γ )} B \qquad ( 3 u )$$

Again R₁ is expressed in the scaled AVO format, resulting in:

$${R}_{l} = [ A + \frac{1 + b}{4 γ ( 2 + b ) - 1} B ] \frac{4 γ ( 2 + b ) - 1}{4 γ ( 1 - 2 γ ) ( 1 + b )} \qquad ( 3 v )$$

Equation (3v) may be referred to as the lithology reflectivity equation. Using the lithology reflectivity equation and the fluid reflectivity equation, the angle transform equation may then be derived. Putting equations (3q) and (3v) side by side, at first, these two equations appear very different. However, it may be understood that α=1/γ_{dry}−4/3. If we substitute this relation into equation 3q, the fluid reflectivity using γ instead of α as variable can be written as,

$${R}_{f} = [ A + \frac{1 + b}{4 {γ}_{dry} ( 2 + b ) - 1} B ] \frac{4 {γ}_{dry} ( 2 + b ) - 1}{4 {γ}_{dry} ( 1 - \frac{γ}{{γ}_{dry}} ) ( 1 + b )} . \qquad ( 3 w )$$

Equation (3w) has exactly the same AVO expression as the equation (3v) does except the scalar. Even though the scalar appears different, but (1-2 γ) in equation (3v) is very close to (1-γ/γ_{dry}) for typical γ_{dry} values. The corresponding reflection angle expression in both equations (3v) and (3w) are the same

$${sin}^{2} θ = \frac{1 + b}{4 γ ( 2 + b ) - 1} \qquad ( 3 x )$$

Equation (3×) can be re-written with variable λ/μ using the relationship 1/γ=2+λ/μ.

$${sin}^{2} θ = \frac{( \frac{λ}{μ} + 2 ) ( 1 + b )}{6 + 4 b - \frac{λ}{μ}} \qquad ( 3 )$$

Referring back to equation (3), the reflection angles are the angles at which a seismic wave optimally reflects or responds when a particular lithology is present. In other words, the optimal seismic response of a particular lithology will occur at the reflection angle determined by Equation (3) through the λ/μ value of that particular lithology. Furthermore, the reflectivity changes depending on the presence or absence of fluid in the rock as well as the type of fluid in the rock (i.e. hydrocarbon or water). As used herein, equation (3) may be referred to as a generalized angle transform equation (GATE).

Equation (3) may be used to determine the reflection angle of the dry rock, θ_{dry}, for each data point in the one or more well logs and also the reflection angle of the saturated rock, θₛₐₜ. The rock may be saturated with brine or gas depending on the lithology measured by the well log. Reflection angle of rock saturated with brine may be determined using Equation (3) and Kₛₐₜ as determined from the one or more well logs.

In an embodiment, once θ_{dry} and θₛₐₜ are determined or calculated, a reflection angle range or window may be calculated at each point in the well logs in block 213. The reflection angle range or window is the difference between θ_{dry} and θₛₐₜ. For purposes of this disclosure, this optimal reflection angle range or window may be referred to as Δθ.

Without being limited by theory, the brine saturated rock is treated as a “lithological” alternative to the dry rock since the saturated rock will have a different λ/μ value from the dry rock. Then Equation (3), the GATE equation, may be used to transform the “wet lithology” to the optimal “wet lithology” reflection angle. Since wet λ/μ is generally greater than the dry λ/μ, the optimal seismic response angle for the wet case is generally greater than that for the dry case. The optimal reflection angle of the same dry rock, but saturated with other type of fluids will fall between these two angles (dry and wet). The difference of these two angles defines Δθ, or the optimal reflection angle range or window. The optimal seismic response angle for the gas will occur near the low end of range or window. The optimal seismic response angle for the wet case will be at the opposite end. The width of the range determines the ability to separate or differentiate the hydrocarbon and brine using seismic data. The larger the difference or separation, the better the reflection angle may serve as a unique indicator of hydrocarbons. More particularly, in embodiments, Δθ may range from about 10 degrees to 0 degrees. In an embodiment, a Δθ value greater than about 3 degrees may indicate that reflection angle may be a good attribute for hydrocarbon identification. In-depth AVO analysis may occur in addition to fluid reflection angle identification.

Referring back to the well log in FIG. 1, 102 shows a sand formation where there gas is located. In row A, θ_{dry} and θₛₐₜ are plotted. The difference, Δθ, between the reflection angles is indicated by the shaded region 105. Thus, the formation indicated by 102 in FIG. 1 would be a good candidate for the usage of θ as an indicator of gas.

Referring back to FIG. 2, the θ_{dry} and θₛₐₜ values for depth intervals known to have hydrocarbons (e.g. 102 in FIG. 1A) may be used in future seismic datasets in the region to detect formation with hydrocarbons in block 215. More particularly, for a given depth interval, if we believe the seismic dataset of a region having θ_{dry} and θₛₐₜ values which are similar to the determined θ_{dry} and θₛₐₜ values from the well logs and the depth interval with a sufficiently large enough Δθ, then the geophysicist may be make a fairly confident assessment of the presence of hydrocarbons within the subsurface region or formation of interest.

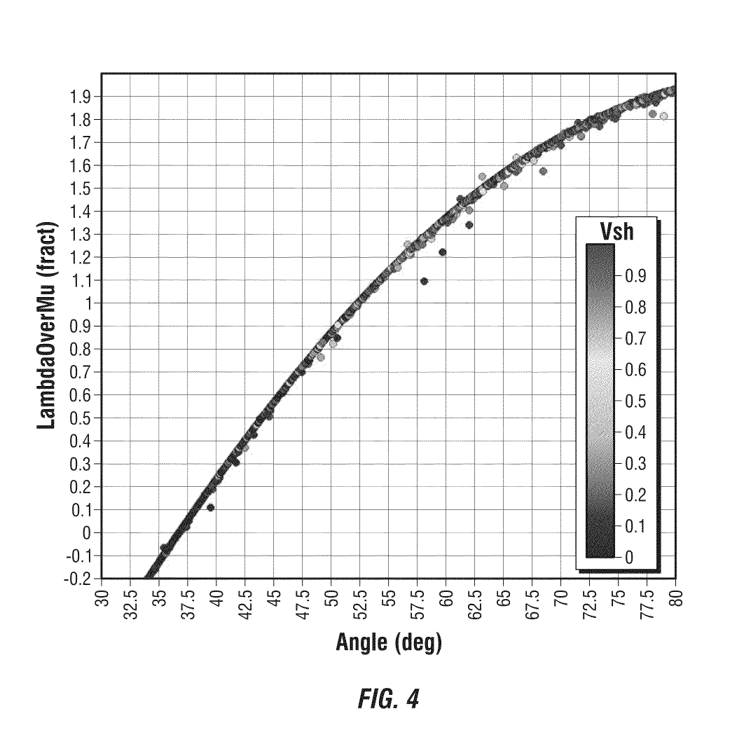

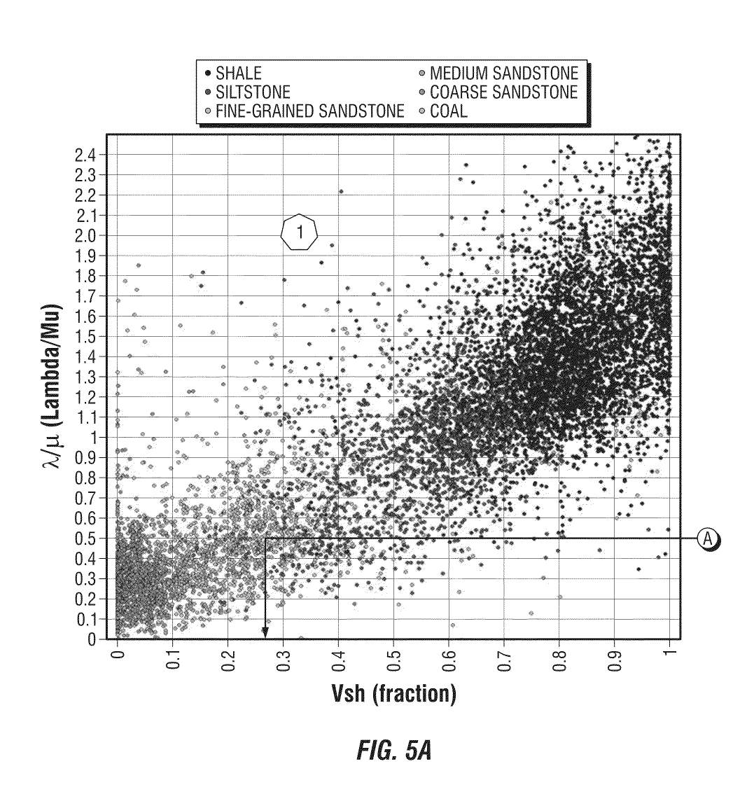

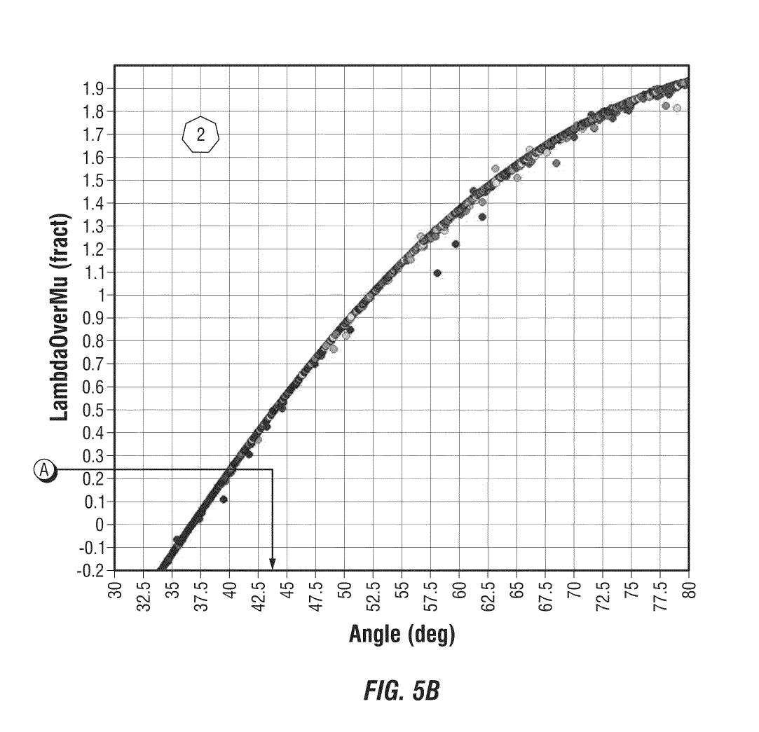

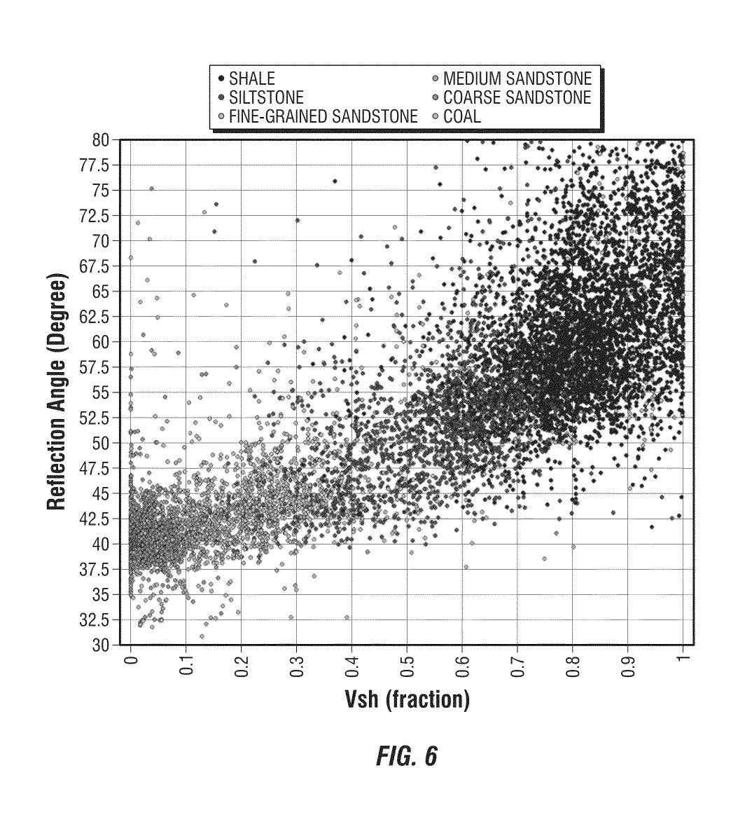

In a further embodiment, Equation (3) may be used a lithology indicator. Referring to FIG. 4, the derived or transformed dry λ/μ values are plotted versus θ, where the θ values were determined by running the λ/μ, values through the GATE equation, Equation (3). Referring now to FIGS. 5A-5B, a cross plot of Vₛₕ v dry λ/μ values is shown compared to the cross plot shown in FIG. 5B to illustrate how θ, the optimal reflection angle, is related to Vₛₕ, and thus, the lithology. The arrows in FIG. 5A-5B illustrate the transform path. Finally, FIG. 6 shows a crossplot of Vₛₕ and θ values and shows how the θ values, derived seismic attributes, may be transformed from one or more elastic properties (i.e. λ/μ values) and may be used as lithological indicators.

Those skilled in the art will appreciate that the disclosed methods may be practiced using any one or combination of hardware and software configurations, including but not limited to a system having single and/or multi-processer computer processors system, hand-held devices, programmable consumer electronics, mini-computers, mainframe computers, supercomputers, and the like. The disclosed methods may also be practiced in distributed computing environments where tasks are performed by servers or other processing devices that are linked through one or more data communications networks. In a distributed computing environment, program modules may be located in both local and remote computer storage media including memory storage devices.

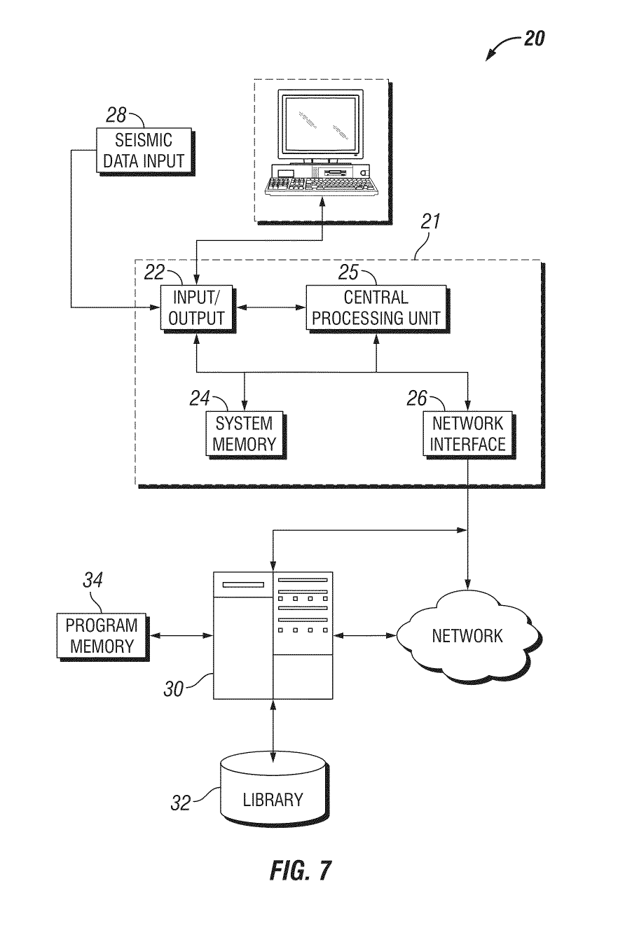

FIG. 7 illustrates, according to an example of an embodiment computer system 20, which may perform the operations described in this specification to perform the operations disclosed in this specification. In this example, system 20 is as realized by way of a computer system including workstation 21 connected to server 30 by way of a network. Of course, the particular architecture and construction of a computer system useful in connection with this invention can vary widely. For example, system 20 may be realized by a single physical computer, such as a conventional workstation or personal computer, or alternatively by a computer system implemented in a distributed manner over multiple physical computers. Accordingly, the generalized architecture illustrated in FIG. 7 is provided merely by way of example.

As shown in FIG. 7 and as mentioned above, system 20 may include workstation 21 and server 30. Workstation 21 includes central processing unit 25, coupled to system bus. Also coupled to system bus BUS is input/output interface 22, which refers to those interface resources by way of which peripheral functions P (e.g., keyboard, mouse, display, etc.) interface with the other constituents of workstation 21. Central processing unit 25 refers to the data processing capability of workstation 21, and as such may be implemented by one or more CPU cores, co-processing circuitry, and the like. The particular construction and capability of central processing unit 25 is selected according to the application needs of workstation 21, such needs including, at a minimum, the carrying out of the functions described in this specification, and also including such other functions as may be executed by computer system. In the architecture of allocation system 20 according to this example, system memory 24 is coupled to system bus BUS, and provides memory resources of the desired type useful as data memory for storing input data and the results of processing executed by central processing unit 25, as well as program memory for storing the computer instructions to be executed by central processing unit 25 in carrying out those functions. Of course, this memory arrangement is only an example, it being understood that system memory 24 may implement such data memory and program memory in separate physical memory resources, or distributed in whole or in part outside of workstation 21. In addition, as shown in FIG. 5, seismic data inputs 28 that are acquired from a seismic survey are input via input/output function 22, and stored in a memory resource accessible to workstation 21, either locally or via network interface 26.

Network interface 26 of workstation 21 is a conventional interface or adapter by way of which workstation 21 accesses network resources on a network. As shown in FIG. 7, the network resources to which workstation 21 has access via network interface 26 includes server 30, which resides on a local area network, or a wide-area network such as an intranet, a virtual private network, or over the Internet, and which is accessible to workstation 21 by way of one of those network arrangements and by corresponding wired or wireless (or both) communication facilities. In this embodiment of the invention, server 30 is a computer system, of a conventional architecture similar, in a general sense, to that of workstation 21, and as such includes one or more central processing units, system buses, and memory resources, network interface functions, and the like. According to this embodiment of the invention, server 30 is coupled to program memory 34, which is a computer-readable medium that stores executable computer program instructions, according to which the operations described in this specification are carried out by allocation system 30. In this embodiment of the invention, these computer program instructions are executed by server 30, for example in the form of a “web-based” application, upon input data communicated from workstation 21, to create output data and results that are communicated to workstation 21 for display or output by peripherals P in a form useful to the human user of workstation 21. In addition, library 32 is also available to server 30 (and perhaps workstation 21 over the local area or wide area network), and stores such archival or reference information as may be useful in allocation system 20. Library 32 may reside on another local area network, or alternatively be accessible via the Internet or some other wide area network. It is contemplated that library 32 may also be accessible to other associated computers in the overall network.

The particular memory resource or location at which the measurements, library 32, and program memory 34 physically reside can be implemented in various locations accessible to allocation system 20. For example, these data and program instructions may be stored in local memory resources within workstation 21, within server 30, or in network-accessible memory resources to these functions. In addition, each of these data and program memory resources can itself be distributed among multiple locations. It is contemplated that those skilled in the art will be readily able to implement the storage and retrieval of the applicable measurements, models, and other information useful in connection with this embodiment of the invention, in a suitable manner for each particular application.

According to this embodiment, by way of example, system memory 24 and program memory 34 store computer instructions executable by central processing unit 25 and server 30, respectively, to carry out the disclosed operations described in this specification, for example, by way of which the elongate area may be aligned and also the stacking of the traces within the elongate area. These computer instructions may be in the form of one or more executable programs, or in the form of source code or higher-level code from which one or more executable programs are derived, assembled, interpreted or compiled. Any one of a number of computer languages or protocols may be used, depending on the manner in which the desired operations are to be carried out. For example, these computer instructions may be written in a conventional high level language, either as a conventional linear computer program or arranged for execution in an object-oriented manner. These instructions may also be embedded within a higher-level application. Such computer-executable instructions may include programs, routines, objects, components, data structures, and computer software technologies that can be used to perform particular tasks and process abstract data types. It will be appreciated that the scope and underlying principles of the disclosed methods are not limited to any particular computer software technology. For example, an executable web-based application can reside at program memory 34, accessible to server 30 and client computer systems such as workstation 21, receive inputs from the client system in the form of a spreadsheet, execute algorithms modules at a web server, and provide output to the client system in some convenient display or printed form. It is contemplated that those skilled in the art having reference to this description will be readily able to realize, without undue experimentation, this embodiment of the invention in a suitable manner for the desired installations. Alternatively, these computer-executable software instructions may be resident elsewhere on the local area network or wide area network, or downloadable from higher-level servers or locations, by way of encoded information on an electromagnetic carrier signal via some network interface or input/output device. The computer-executable software instructions may have originally been stored on a removable or other non-volatile computer-readable storage medium (e.g., a DVD disk, flash memory, or the like), or downloadable as encoded information on an electromagnetic carrier signal, in the form of a software package from which the computer-executable software instructions were installed by allocation system 20 in the conventional manner for software installation.

While the embodiments of the invention have been shown and described, modifications thereof can be made by one skilled in the art without departing from the spirit and teachings of the invention. The embodiments described and the examples provided herein are exemplary only, and are not intended to be limiting. Many variations and modifications of the invention disclosed herein are possible and are within the scope of the invention. Accordingly, the scope of protection is not limited by the description set out above, but is only limited by the claims which follow, that scope including all equivalents of the subject matter of the claims.

The discussion of a reference is not an admission that it is prior art to the present invention, especially any reference that may have a publication date after the priority date of this application. The disclosures of all patents, patent applications, and publications cited herein are hereby incorporated herein by reference in their entirety, to the extent that they provide exemplary, procedural, or other details supplementary to those set forth herein.

What is claimed is:

1. A method of identifying the presence of hydrocarbons, the method comprising:
(a) acquiring one or more well logs from a subsurface region of interest, the one or more well logs comprising one or more petrophysical properties;
(b) calculating one or more dry elastic properties using the one or more petrophysical properties to determine a plurality of dry reflection angles;
(c) transforming the one or more elastic properties for a selected depth interval from the one or more well logs into a plurality of wet reflection angles;
(d) comparing the dry reflection angles and the wet reflection angles to quantify a fluid discrimination measurement; and
(e) based on the fluid discrimination measurement, using the reflection angles in (b) and (c) to identify one or more hydrocarbon formations in a seismic dataset from another subsurface region of interest, and wherein at least one of (b) through (e) is performed on a computer.

2. The method of claim 1 wherein the one or more dry elastic properties comprises a plurality bulk and shear moduli values and the one or more petrophysical properties comprises a plurality of Vₛₕ values.

3. The method of claim 1 wherein (b) and (c) further comprise using the equation:
$${sin}^{2} θ = \frac{( \frac{λ}{μ} + 2 ) ( 1 + b )}{( 6 + 4 b - \frac{λ}{μ} )}$$
where b is a Gardner power coefficient, λ is Lamè's first constant and μ is shear modulus, and θ is the fluid reflection angle, to transform the one or more petrophysical properties into a plurality of fluid reflection angles.

4. The method of claim 1 wherein b is constant.

5. The method of claim 1 wherein (b) comprises using the equation:
$${K}_{sat} - {K}_{dry} \approx {( 1 - \frac{{K}_{dry}}{{K}_{m}} )}^{2} ( \frac{{K}_{f}}{φ} )$$
where Kₛₐₜ is the bulk modulus of saturated rock, K_{dry} is the bulk modulus of dry rock, Kₘ is the bulk modulus of mineral, K_{f} is the bulk modulus of fluid, and φ is the porosity, to calculate the dry bulk modulus.

6. The method of claim 1 wherein the fluid discrimination measurement in (e) is the difference between the dry reflection angle and the wet reflection angle.

7. A method of identifying the lithology of a subsurface region of interest, the method comprising:
(a) acquiring one or more well logs from a subsurface region of interest, the one or more well logs comprising one or more petrophysical and lithological properties;
(b) calculating a bulk and shear moduli using the one or more petrophysical properties to determine a plurality of reflection angles; and
(c) plotting the plurality of reflection angles and the one or more lithological properties to determine a relationship between the one or more lithological properties and the reflection angles, wherein (b) and (c) are performed on a computer.

8. The method of claim 7 wherein the one or more petrophysical properties comprises a plurality of Vₛₕ and λ/μ values.

9. The method of claim 7 wherein (b) further comprise using the equation:
$${sin}^{2} θ = \frac{( \frac{λ}{μ} + 2 ) ( 1 + b )}{( 6 + 4 b - \frac{λ}{μ} )}$$
where b is a Gardner power coefficient, λ is Lamè's first constant and μ is shear modulus, and θ is the reflection angle, to transform the one or more petrophysical properties into a plurality of reflection angles.

10. The method of claim 7 wherein b is constant.

11. The method of claim 7 wherein (b) comprises using the equation:
$${K}_{sat} - {K}_{dry} \approx {( 1 - \frac{{K}_{dry}}{{K}_{m}} )}^{2} ( \frac{{K}_{f}}{φ} )$$
where Kₛₐₜ is the bulk modulus of saturated rock, K_{dry} is the bulk modulus of dry rock, Kₘ is the bulk modulus of mineral, K_{f} is the bulk modulus of fluid, and φ is the porosity, to calculate the dry bulk modulus.

12. A computer system, comprising:
an interface for receiving one or more well log datasets, the well log datasets comprising one or more petrophysical properties;
a memory resource;
input and output functions for presenting and receiving communication signals to and from a human user;
one or more central processing units for executing program instructions; and program memory, coupled to the central processing unit, for storing a computer program including program instructions that, when executed by the one or more central processing units, cause the computer system to perform a plurality of operations for identifying one or more hydrocarbon formations, the plurality of operations comprising:
(a) calculating one or more dry elastic properties using the one or more petrophysical properties to determine a plurality of dry reflection angles;
(b) transforming the one or more elastic properties for a selected depth interval from the one or more well logs into a plurality of wet reflection angles;
(c) comparing the dry reflection angles and the wet reflection angles to quantify a fluid discrimination measurement; and
(d) based on the fluid discrimination measurement, using the wet and dry reflection angles in (a) and (b) to identify one or more hydrocarbon formations in a seismic dataset from another subsurface region of interest.

13. The system of claim 12 wherein the one or more dry elastic properties comprises a plurality bulk and shear moduli values and the one or more petrophysical properties comprises a plurality of Vₛₕ values.

14. The system of claim 12 wherein (a) and (b) further comprise using the equation:
$${sin}^{2} θ = \frac{( \frac{λ}{μ} + 2 ) ( 1 + b )}{( 6 + 4 b - \frac{λ}{μ} )}$$
where b is a Gardner power coefficient, λ is Lamè's first constant and μ is shear modulus, and θ is the P-wave reflection angle, to transform the one or more petrophysical properties into a plurality of P-wave reflection angles.

15. The system of claim 12 wherein b is constant.

16. The system of claim 12 wherein the fluid discrimination measurement in (d) is the difference between the dry reflection angle and the wet reflection angle.

17. The system of claim 12 wherein (a) comprises using the equation:
$${K}_{sat} - {K}_{dry} \approx {( 1 - \frac{{K}_{dry}}{{K}_{m}} )}^{2} ( \frac{{K}_{f}}{φ} )$$
where Kₛₐₜ is the bulk modulus of saturated rock, K_{dry} is the bulk modulus of dry rock, Kₘ is the bulk modulus of mineral, K_{f} is the bulk modulus of fluid, and φ is the porosity, to calculate the dry bulk modulus.
